(19) United States
(12) Patent Application Publication
(10) Pub. No.: US 2010/0043249 A1
(43) Pub. Date: Feb. 25, 2010

(54) Portable Dish Dryer with Drying Lamp

(76) Inventor: Azanaw Mulaw, Fort Washington, MD (US)

Correspondence Address: MUSKIN & CUSICK LLC, 100 West Main Street, SUITE 205, Lansdale, PA, 19446, US

(21) Appl. No.: 12/197,553

(22) Filed: Aug. 25, 2008

(51) Int. Cl. F26B 3/34; F26B 25/06; F26B 25/00

(52) U.S. Cl. 34/275; 34/229; 34/239

(57) ABSTRACT

A portable dish drying apparatus. The dish drying apparatus uses a heat lamp to dry dishes, which can be controlled using a control panel located on an outside surface of the apparatus. A video output device can be embedded on a front door, cover, or lid of the apparatus in order to allow a user to watch television.

### BACKGROUND OF THE INVENTION

1. Field of the Invention

The present inventive concept relates to a portable dish drying unit that dries dishes using a lamp.

2. Description of the Related Art

Dish dryers are typically large, stationary items which are obtrusive and noisy.

What is needed is a small, portable manner in which to quietly dry dishes and other household items.

### SUMMARY OF THE INVENTION

It is an aspect of the present general inventive concept to provide an improved dish drying device.

The above aspects can be obtained by an apparatus that includes (a) a door connected to the dish drying apparatus which opens and closes; (b) an inside floor, inside ceiling, and inside walls of the dish drying apparatus; (c) a rack mounted inside the drying apparatus to hold dishes; and (d) a lamp attached to a surface of the dish drying apparatus.

The above aspects can also be obtained by an apparatus that includes (a) a retractable cover connected to the dish drying apparatus which extends and retracts; (b) an inside floor, inside ceiling, and inside walls of the dish drying apparatus; (c) a rack mounted inside the drying apparatus to hold dishes; and (d) a lamp attached to the ceiling.

The above aspects can also be obtained by an apparatus that includes (a) a lid connected to the dish drying apparatus which opens and closes; (b) an inside floor, inside ceiling, and inside walls of the dish drying apparatus; (c) a rack mounted inside the drying apparatus to hold dishes; (d) a lamp attached to an inside surface of the lid; and (e) a control panel on an outside of the dish drying apparatus to control the lamp.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a front view of a portable dish dryer, according to an embodiment;

FIG. 2 is a side view of a portable dish dryer, according to an embodiment;

FIG. 3 is an orthogonal view of a portable dish dryer, according to an embodiment;

FIG. 4 is an orthogonal view of a portable dish dryer with a lid in an open position, according to an embodiment;

FIG. 5 is an orthogonal view of a portable dish dryer with a retractable cover;

FIG. 6A is a front view of a portable dish dryer with a retractable cover with a retracted drip tray, according to an embodiment;

FIG. 6B is a front view of a portable dish dryer with a retractable cover with an extended drip tray, according to an embodiment;

FIG. 7 is a front view of a portable dish dryer with an embedded television display, according to an embodiment;

FIG. 8 is an orthogonal view of a portable dish dryer with an open retractable cover, according to an embodiment;

FIG. 9 is a drawing of light bulb, vent, and internal fan, according to an embodiment;

FIG. 10 is an orthogonal view of a dish dryer embodied in a cabinet with its door open, according to an embodiment;

FIG. 11 is an orthogonal view of a dish dryer embodied in a cabinet with its door closed, according to an embodiment; and

FIG. 12 is a view of a dish dryer embodied in a cabinet mounted inside a wall, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

Embodiments of the invention relate to a portable dish drying apparatus. The portable dish drying apparatus is a free standing, covered, counter top dish rack. From a structural perspective, the counter top rack differs from a standard dishwasher because the counter top rack does not connect to a water supply, does not incorporate a waterproof seal, does not incorporate a water sprayer, and does not need a waterproof cover.

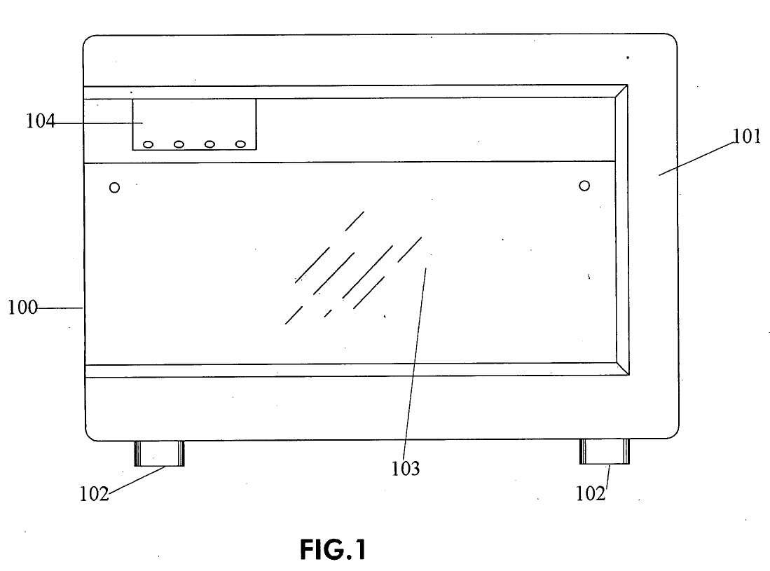

FIG. 1 is a front view of a portable dish dryer, according to an embodiment.

A portable dish dryer 100 is disclosed. In this embodiment, the dish dryer 100 has a square shape with a door frame 101 that houses a glass window 103. The door frame 101 can open and close. Legs 102 on the dish dryer 100 are used to stabilize the dish dryer 100. A control panel 104 is used to control operation of the drying, for example, controlling the lamp (not pictured) used to sterilize dishes inside the portable dish dryer 100 (not pictured). The lamp can comprise an ultraviolet lamp for sterilizing dishes and/or a heat lamp for drying dishes as well.

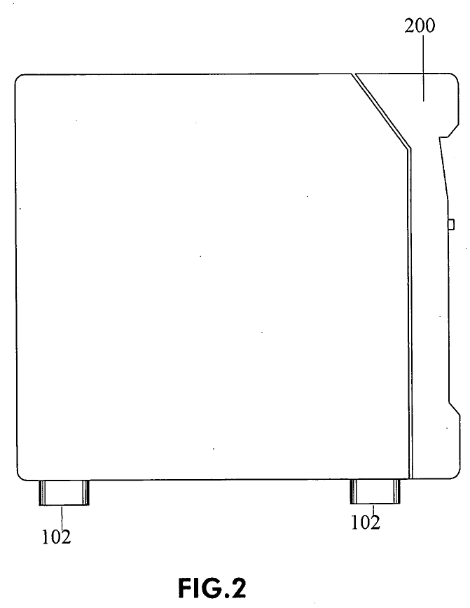

FIG. 2 is a side view of a portable dish dryer, according to an embodiment.

A door frame 200 is used to house the glass door 103. The door frame 200 and the glass door 103 can swing open and closed.

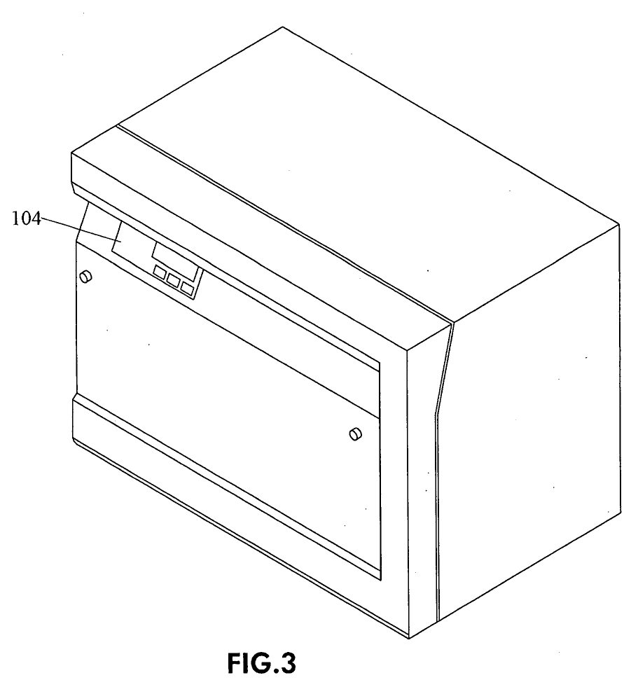

FIG. 3 is an orthogonal view of a portable dish dryer, according to an embodiment.

A control panel 104 can be used to individually control the lamp inside and/or the fan and/or any video output display attached to the dish dryer (not pictured in FIG. 3). The control panel can also implement a timing device that turns the lamp on or off after a predetermined amount of time (e.g., keeps the lamp on for three hours then turns it off automatically).

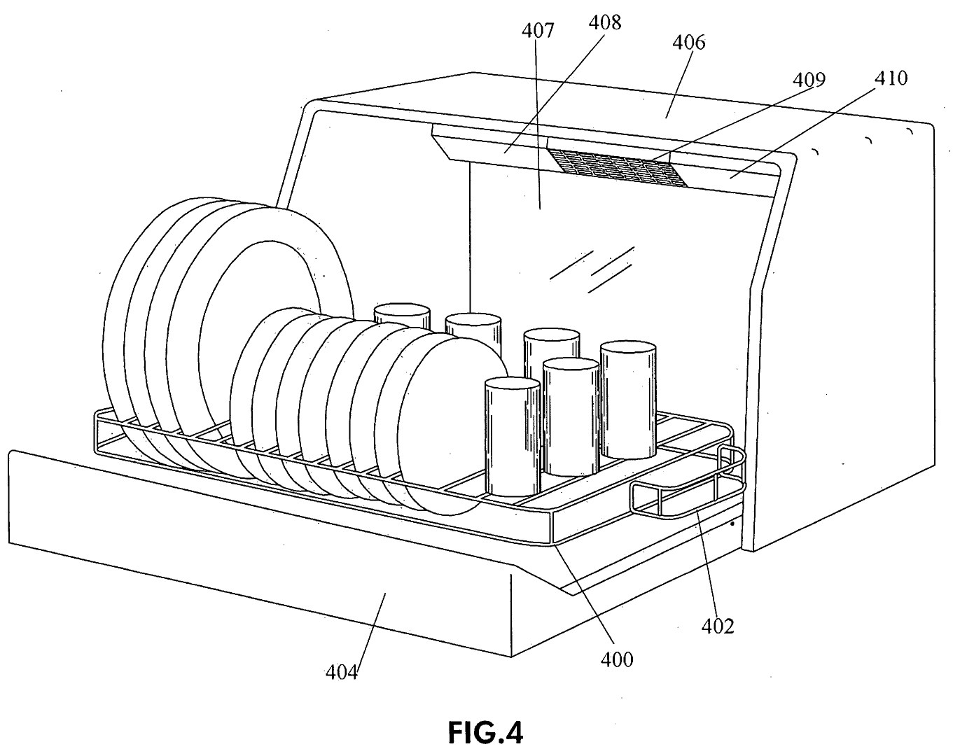

FIG. 4 is an orthogonal view of a portable dish dryer with a lid in an open position, according to an embodiment.

The base 404 from the closed position (illustrated in FIG. 3) is pulled downward in order to open this embodiment of the dish dryer. The dish tray 400 then automatically slides out onto the base 404 using a spring mechanism (not pictured). When the base 404 is closed (lifted), the force of the base 404 will push the dish tray 400 back towards the back of the dish tray 400, so the base 404 can then close.

A base 404 holds the dish tray 400 which has a drawer 402 embedded inside the dish tray 400. The drawer 402 can open and close and can be used to hold items such as forks knifes, etc. A lid 406 can be raised to put the dryer in the open position (as shown). The lid 406 can also be lowered over the base 404, thereby closing the dish dryer.

A drying lamp 408 is attached to an inside surface 407 of the lid 406. The drying lamp can be any type of lamp such as a standard light bulb, UV light, etc.

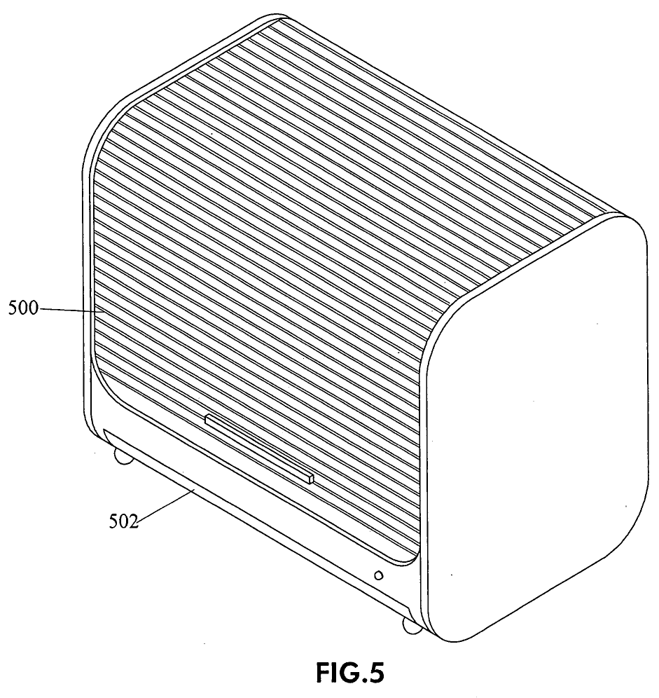

FIG. 5 is an orthogonal view of a portable dish dryer with a retractable cover.

A retractable cover 500 can slide open and shut. A drip tray 502 can also extend or retract (as illustrated) inside the portable dish dryer. FIG. 5 shows the cover 500 in the shut (or closed or extended) position.

The drip tray can be used to collect water or other liquids. For example, when wet dishes are placed inside the dish dryer, the tray can be used (if extended) to collect water that may drip from the dishes (or other utensils).

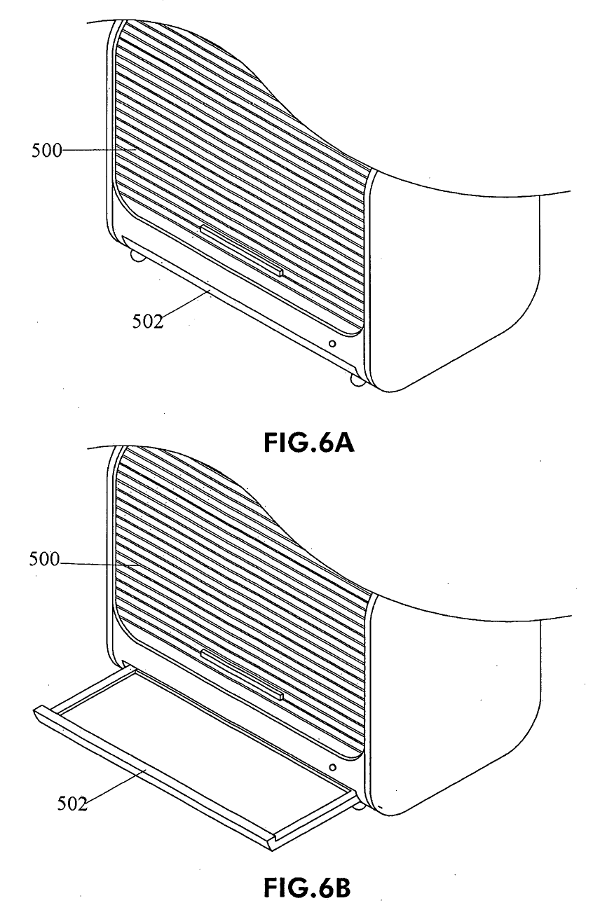

FIG. 6A is a front view of a portable dish dryer with a retractable cover with a retracted drip tray, according to an embodiment.

The retractable cover 500 is closed, and the drip tray 502 is retracted.

FIG. 6B is a front view of a portable dish dryer with a retractable cover with an extended drip tray, according to an embodiment.

The retractable cover 500 is closed and the drip tray 502 is in the extended position.

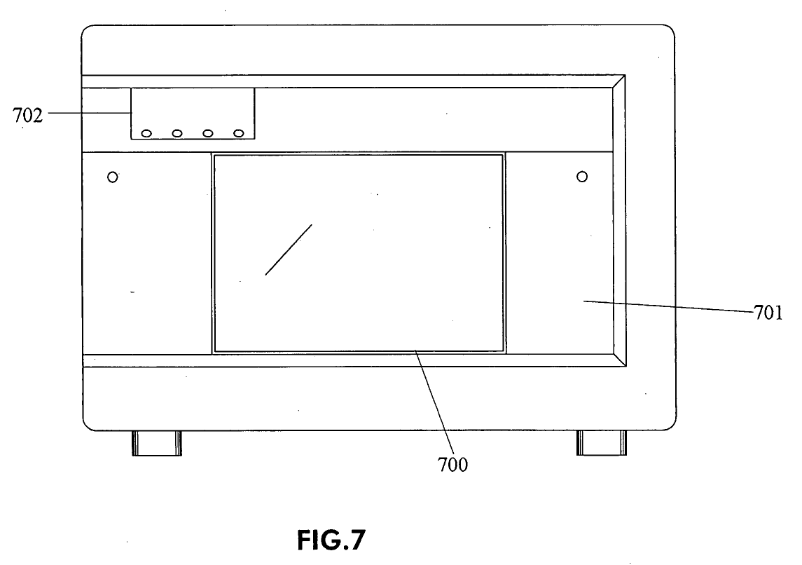

FIG. 7 is a front view of a portable dish dryer with an embedded television display, according to an embodiment.

A video output display 700 is embedded on a door 701. The door 701 can open and close. The video output display 700 can be turned on/off as well as controller by a control panel 702. The video output display can be used to watch television shows, DVDs, etc. The video output display 700 can be any electronic visual output device, such as a plasma display, LCD display, CRT, etc. Additional circuitry used to drive the video output display 700 is not pictured and already known in the art (e.g., tuner, power supply, inputs jacks, etc.)

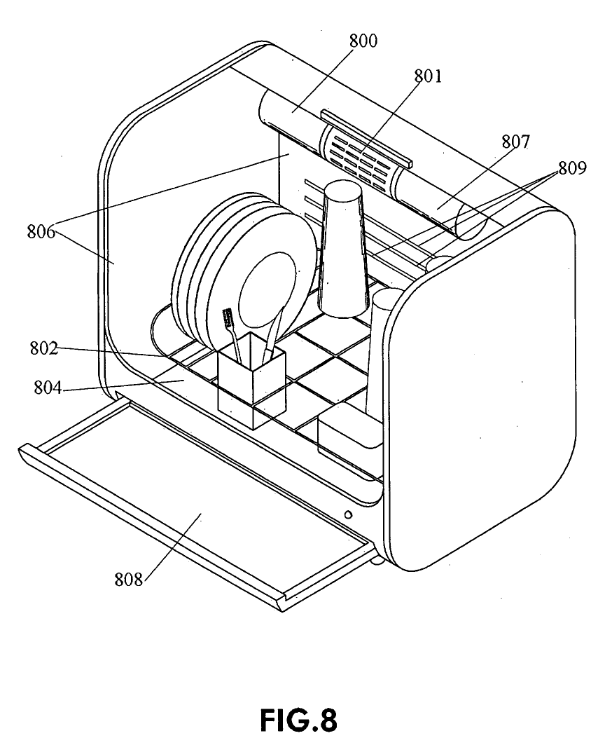

FIG. 8 is an orthogonal view of a portable dish dryer with an open retractable cover, according to an embodiment. This view shows the portable dish dryer of FIG. 5 with the cover in the open (retracted) position.

A dish rack 802 is visible inside the portable dish dryer and is used to hold dishes, utensils, cups, etc. A lamp (such as an ultraviolet lamp) 800, 807 is used to dry the dishes and is controlled by a control panel located on an outside of the portable dish dryer. The drying lamp 800, 807 can be powered either by batteries (not pictured) or by a power cord (not pictured). The control panel can turn the lamp 800, 807 on and off as well as optionally set an intensity of the lamp, set a timer, etc.

Also illustrated are an inside floor 804, an inside ceiling 805, and inside walls 806. The lamp (such as an ultraviolet lamp or drying lamp) 800, 807 is mounted on the ceiling 805, although in other embodiments the drying lamp 800,807 can be mounted on any other location inside the dish dryer. A cylindrical grating 801 contains a fan inside (not pictured in FIG. 8). Optional vents 809 can allow air to circulate in and out of the dish dryer.

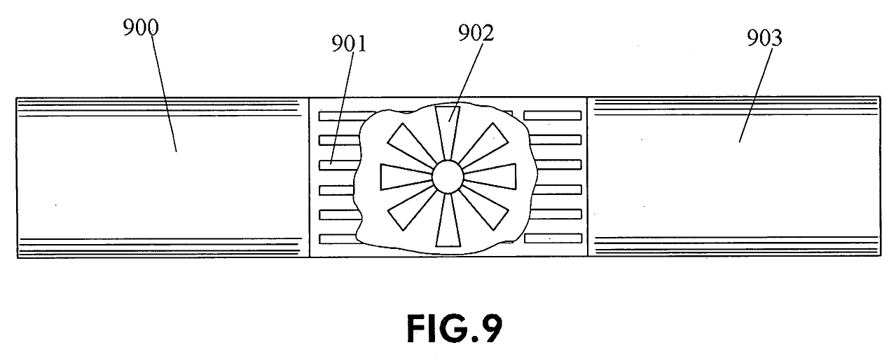

FIG. 9 is a drawing of light bulb, vent, and internal fan, according to an embodiment.

A left light bulb 900 and a right light bulb 903 are used to heat the dishes inside the dish dryer. In this embodiment, the left light bulb 900, the right light bulb 903, and a grating 901 are cylindrical.

Between the left light bulb 900 and the right light bulb 903 is the cylindrical grating 901. The grating 901 has openings to allow air to pass through it. Inside the grating 901 is a fan 902 which is operated using a power supply (not pictured) and a control switch (not pictured). The fan 902 circulates air inside the dish dryer. Air can circulate in an out of the dish dryer through the vents 809 (see FIG. 8). The fan can be controlled by the control panel, that is, switches (or other mechanical mechanisms) can be placed on an outside (or alternatively inside) of the dish dryer so that the user can control the fan (e.g., turn it on/off and optionally adjust its power level).

In a further embodiment, a dish dryer with any combination of feature(s) as described herein, can also be embodied in a cabinet form which can be mounted in a wall.

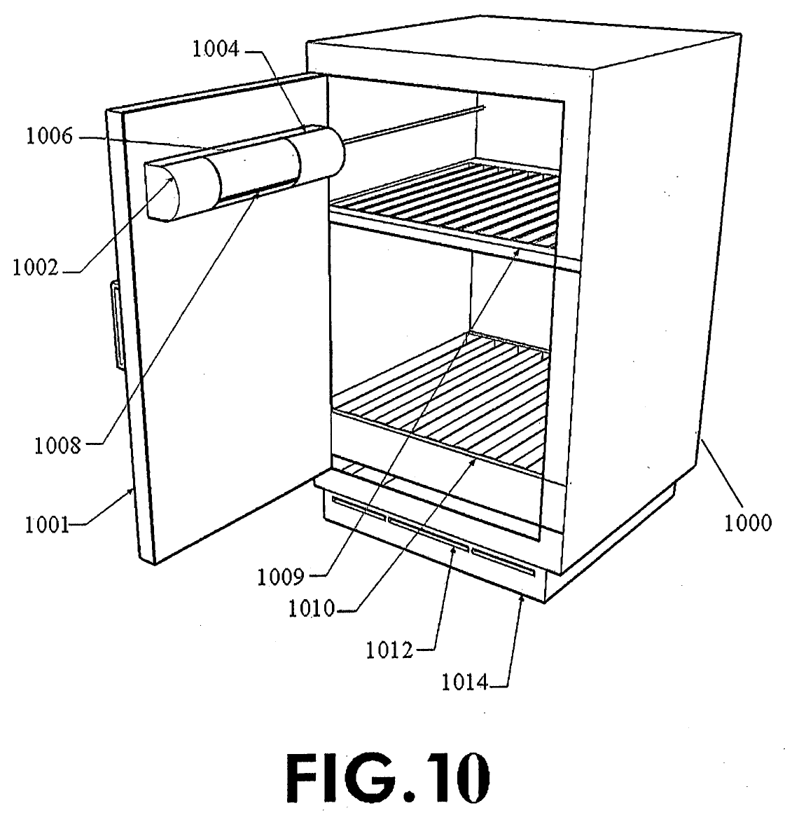

FIG. 10 is an orthogonal view of a dish dryer embodied in a cabinet with its door open, according to an embodiment.

A wall mounted cabinet dish dryer 1000 comprises a cabinet door 1001 can open and close. A left UV light 1002 and a right UV light 1004 can be attached to the cabinet door 1001 (or other internal part of the cabinet). A squirrel cage fan 1006 can be located between the left UV light 1002 and the right UV light 1004. An air inlet 1008 can also be located near the squirrel cage fan 1006 and can allow outside air to enter the wall mounted cabinet dish dryer 1000.

A glasses rack 1009 can be used to hold glasses (not pictured). A dish rack 1010 can be used to hold dishes (not pictured). An air vent outlet 1012 allows air to leave the dish dryer 1000. A removable drip tray 1014 can be used to catch liquids which may drip from the glasses and/or dishes above.

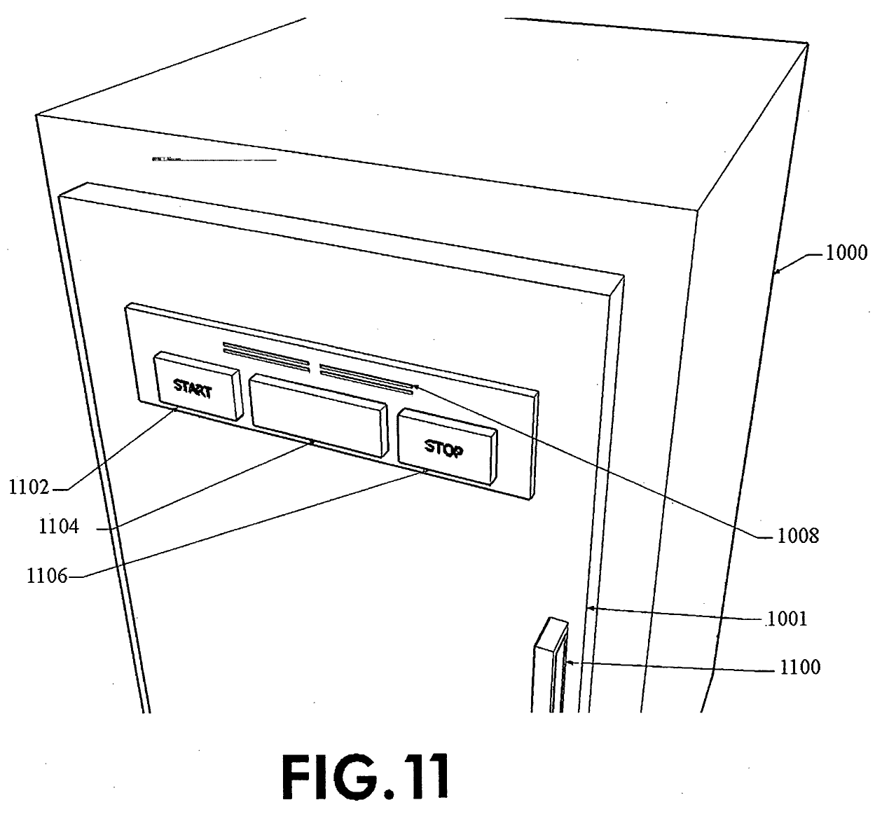

FIG. 11 is an orthogonal view of a dish dryer embodied in a cabinet with its door closed, according to an embodiment.

The wall mounted cabinet dish dryer 1000 has air inlets 1008, a door 1001, and a handle 1100 attached to the door 1001.

A start button 1102 can be used to turn on the UV lamp(s) inside the wall mounted cabinet dish dryer and also start the fan 1006 as well. A power indicator light 1104 can be used to indicate that the wall mounted cabinet dish dryer 1000 has power. A stop button 1106 can be used to turn off the UV lamp(s) inside the wall mounted cabinet dish dryer 1000.

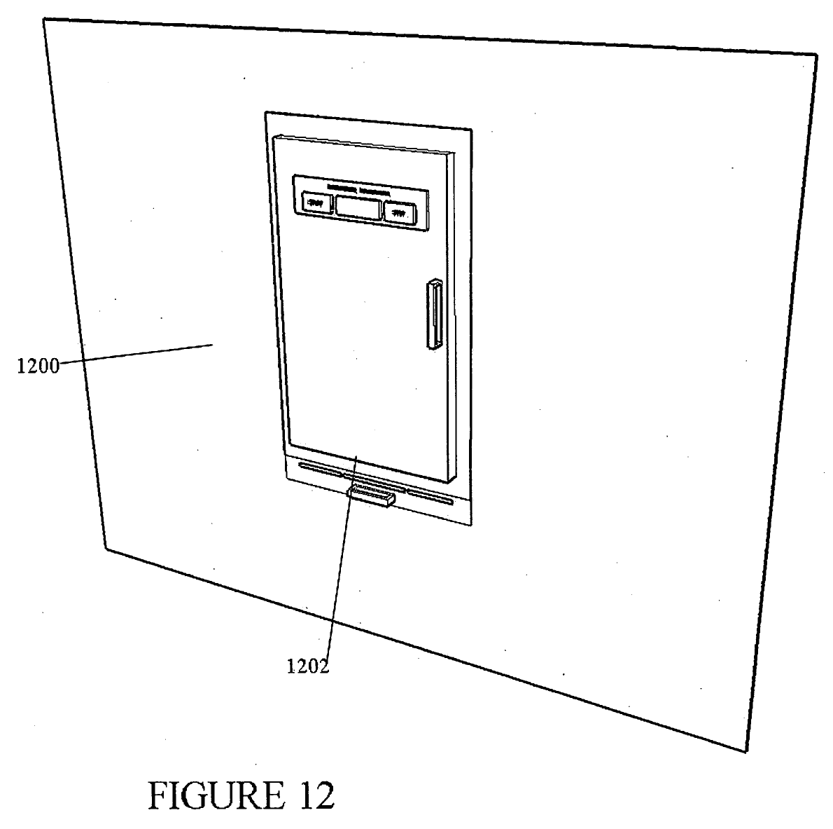

FIG. 12 is a view of a dish dryer embodied in a cabinet mounted inside a wall, according to an embodiment.

A dish dryer embodiment in a cabinet 1202 is mounted inside a wall 1200. The dish dryer embodiment in a cabinet 1202 can have any combination of the feature(s) described herein.

As used herein, a “light bulb” can mean a standard light bulb, ultraviolet bulb, heat lamp, etc. A “lamp” used herein can mean an ultraviolet lamp or any other type of lamp used for sterilization. The “lamp” can also be a drying lamp which uses a standard bulb.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A portable dish drying apparatus, the apparatus comprising:
a door connected to the dish drying apparatus which opens and closes;
an inside floor, inside ceiling, and inside walls of the dish drying apparatus;
a rack mounted inside the drying apparatus to hold dishes; and
a lamp attached to a surface of the dish drying apparatus.

2. The apparatus as recited in claim 1, wherein the lamp is an ultraviolet lamp.

3. The apparatus as recited in claim 1, further comprising a control panel on an outside of the dish drying apparatus to control the lamp.

4. The apparatus as recited in claim 1, further comprising:
a retractable drip tray located on a bottom of the portable dish drying apparatus, the drip tray capable of extending outside of the portable dish drying apparatus and retracting inside the portable dish drying apparatus.

5. The apparatus as recited in claim 1, further comprising:
a video display output device embedded on an outside of the door.

6. The apparatus as recited in claim 1, further comprising a fan located inside the apparatus.

7. The apparatus as recited in claim 6, further comprising a control panel on an outside of the dish drying apparatus to control the fan.

8. The apparatus as recited in claim 6, further comprising a control panel on an outside of the dish drying apparatus to control both the lamp and the fan.

9. The apparatus as recited in claim 6, wherein the lamp comprises a left lamp and a right lamp, and a cylindrical grating in between the left lamp and the right lamp with the fan inside the cylindrical grating.

10. A portable dish drying apparatus, the apparatus comprising:
a retractable cover connected to the dish drying apparatus which extends and retracts;
an inside floor, inside ceiling, and inside walls of the dish drying apparatus;
a rack mounted inside the drying apparatus to hold dishes; and
a lamp attached to the ceiling.

11. The dish drying apparatus as recited in claim 10, wherein the lamp is an ultraviolet lamp.

12. The dish drying apparatus as recited in claim 10, further comprising a control panel on an outside of the dish drying apparatus to control the lamp.

13. The apparatus as recited in claim 10, further comprising:
a retractable drip tray located on a bottom of the portable dish drying apparatus, the drip tray capable of extending outside of the portable dish drying apparatus and retracting inside the portable dish drying apparatus.

14. The apparatus as recited in claim 10, further comprising:
a video output device embedded on an outside of the cover.

15. The dish drying apparatus as recited in claim 10, further comprising a fan.

16. The dish drying apparatus as recited in claim 15, wherein the fan is mounted inside a cylindrical grating mounted inside the dish dryer.

17. The dish drying apparatus as recited in claim 15, wherein the dish drying apparatus further comprises vents to allow air to circulate inside and outside of the dish drying apparatus.

18. A portable dish drying apparatus, the apparatus comprising:
a lid connected to the dish drying apparatus which opens and closes;
an inside floor, inside ceiling, and inside walls of the dish drying apparatus;
a rack mounted inside the drying apparatus to hold dishes;
a lamp attached to an inside surface of the lid; and
a control panel on an outside of the dish drying apparatus to control the lamp.

19. The apparatus as recited in claim 18, further comprising:
a retractable drip tray located on a bottom of the portable dish drying apparatus, the drip tray capable of extending outside of the portable dish drying apparatus and retracting inside the portable dish drying apparatus.

20. The apparatus as recited in claim 18, further comprising:
a video output device embedded on an outside of the lid.

21. The dish drying apparatus as recited in claim 18 further comprising a fan.

22. The dish drying apparatus as recited in claim 20, wherein the fan is mounted inside a cylindrical grating mounted inside the dish dryer.

23. A dish drying apparatus embodied in a cabinet, the apparatus comprising:
a door connected to the dish drying apparatus which opens and closes;
an inside floor, inside ceiling, and inside walls of the dish drying apparatus;
a rack mounted inside the drying apparatus to hold dishes; and
a lamp attached to a surface of the dish drying apparatus.

24. The apparatus as recited in claim 23, further comprising a fan located inside the dish drying apparatus.

25. The apparatus as recited in claim 24, further comprising a control panel on an outside of the dish drying apparatus to control both the lamp and the fan.

26. The dish drying apparatus as recited in claim 23, wherein the dish drying apparatus is mounted inside a wall.
